(19) United States
(12) Patent Application Publication
(10) Pub. No.: US 2025/0066163 A1
(43) Pub. Date: Feb. 27, 2025

(54) WIND TURBINE INSTALLATION SYSTEM AND METHOD FOR INSTALLATION OF A WIND TURBINE

(71) Applicant: ENABL A/S, Hedensted (DK)

(72) Inventors: Henrik VAGTHOLM, Gelsted (DK); Jon SVENNINGGAARD, Horsens (DK)

(21) Appl. No.: 18/729,244

(22) PCT Filed: Jan. 25, 2023
(86) PCT No.: PCT/DK2023/050013

§ 371 Date: Jul. 16, 2024

(30) Foreign Application Priority Data
Jan. 25, 2022 (DK) PA 2022 70031

(51) Int. Cl. B66C 1/10; B66C 23/18; F03D 13/10

(52) U.S. Cl. CPC B66C 1/108; B66C 23/185; F03D 13/10

(57) ABSTRACT

A wind turbine installation system and a method for installation of an offshore or onshore wind turbine including a tower is provided. The system includes at least one winch and a winch control system, the winch has a winch motor and a bi-directional rotational spool with a strap, wherein the winch is placed on an installation vessel or on the ground, wherein said the strap is provided with attachment for attachment to a tower, a nacelle or a fundament of the wind turbine and for applying a controlled pull on the tower, nacelle or fundament. A control system is controllably connected to the winch motor for controlling spool rotation in order to induce counter movements to the registered oscillations occurring in the tower and thereby stabilize the tower.

### CROSS-REFERENCE TO RELATED APPLICATIONS

This application is a national stage of PCT Application No. PCT/DK2023/050013, having a filing date of Jan. 25, 2023, which is based DK Application No. PA 2022 70031, having a filing date of Jan. 25, 2022, the entire contents both of which are hereby incorporated by reference.

### FIELD OF TECHNOLOGY

The following relates to a wind turbine installation system for installation of an onshore wind turbine or an offshore wind turbine comprising a tower and a nacelle arranged on a fundament, wherein the system comprises
a crane arrangement and at least one winch,
a control arrangement which comprises a winch control system and a monitoring device, which is arranged for monitoring the relative movements/oscillation of the tower relative to a ground when installing an onshore wind turbine or relative to a vessel when installing an offshore wind turbine and which monitoring device is arranged at the tower or nacelle.

Furthermore, the following relates to a method for installation an onshore wind turbine or an offshore wind turbine comprising a tower and a nacelle arranged on a fundament, which method comprises the steps of
providing a crane for lifting wind turbine components and positioning the crane at a site of installation of the wind turbine,
providing a winch arrangement, comprising at least one winch,
providing a control arrangement which comprises a winch control system and a monitoring device, which is arranged for monitoring the relative movements/oscillation of the tower and which monitoring device is arranged at the tower or nacelle,
positioning a monitoring device, which is arranged for monitoring the relative movements/oscillation of the tower relative to a ground when installing an onshore wind turbine or relative to a vessel when installing an offshore wind turbine,
connecting the monitoring device with the control system.

Furthermore, embodiments of the invention relate to a method for installation of an offshore wind turbine comprising a tower and a nacelle, which method comprises the steps of providing an installation vessel provided with a crane for lifting wind turbine components and positioning the installation vessel at a site of installation of the offshore wind turbine.

In the present application a fundament may be a monopile in an offshore wind turbine.

### BACKGROUND

Embodiments of the invention are specifically developed in connection with a marine vessel for installation wind turbine components to offshore windfarms. The wind turbine components (including, but not limited to nacelles, blades and towers) are placed on a marine vessel which is transporting the components from a logistics harbor/quayside to the offshore site for installation. At the offshore site, the components are lifted from the vessel and onto pre-installed foundations using a large marine crane.

However, embodiments of the invention may also be used for other components, for example component for offshore oil exploitation platforms or other offshore constructions. Especially such constructions which are placed on monopiles which are influenced by wave movements and ocean currents.

In the following, embodiments of the invention will be explained in connection with fastening the straps to a wind turbine tower, however instead of fastening the straps to the tower it is possible that the straps are fastened to a monopile on which a tower section is mounted.

The operational steps for the installation of the wind turbine tower components involves a number of steps.

After placing the components on the vessel deck at a quayside, the components are secured to the vessel normally using bolted or welded sea fastening connections.

Later when the components are to be removed from the vessel at the offshore site, the sea fastening connections shall be disconnected.

Components may be lifted from a floating vessel via a crane mounted on same or another vessel. The vessel may be a feeder barge.

The need for green energy is accelerating, resulting in increased demand for the installation of more wind power energy. The leading suppliers of wind turbine generators WTG's are continuously announcing the development and implementation of even bigger WTG's. As a result, the offshore wind industry will continue to face more challenges relating to the installation of WTG components in the future.

The design of wind turbine towers and monopile foundations are getting bigger, however they are being designed in a way that they are unstable-causing oscillating movement under the influence of current waves and/or wind. As a result, the burden (nacelle and blades) cannot be installed without causing risk and danger to the crew and damages to the installation tools and WTG components.

These oscillating movements can measure more than 400 mm in amplitude, and therefore often cause delays in the installation process. In a specific case where the installation of a WTG was expected to take 3 days (including transport at sea), the oscillating movements of the tower caused delays of up to 12 days per WTG. These delays can have major financial consequences. The direct costs in relation to the installation vessel are between 1.5-4.0 MDKK/day. Therefore, these delays significantly impact the cost of energy. Typically, during installation an amplitude of 50 mm is acceptable.

Another significant short-term challenge in the wind industry is posed by the introduction of floating installation vessels. The vessels are designed to operate on deeper sea levels, where the Jack Up vessels cannot operate. Typically, the maximum sea depth for Jack Up Vessel is 60 meters. The Jack Up vessels have the advantage that they stand on the sea floor, thereby creating a relatively stable foundation for the installation. This means that the crane on the installation vessel is stable during installation and therefore able to safely install the WTG components in combination with a tag line and guide wire system.

The floating vessels will be more sensitive to wind and wave conditions with the consequence of having a more confined operation window for installation. They compensate for this by adding an active heave compensation system to the crane, which in turn eliminates the vertical movement of the burden.

However, the horizontal translational degrees of freedom are still free, which makes the burden move in these directions.

Today there exist tagline master solutions, which allow for a safe and controlled guiding process of rotors, nacelles, and single blades in any site condition, both onshore & off-shore. They provide for a handling of heavy loads in cooperation with the cranes. The challenge with today's tagline solution is that it is mounted on the crane and will therefore follow the crane in all its movement. For example, if the crane is placed on a floating vessel, the burden will follow the crane if it is impacted by waves or wind. While the floating vessels have systems to adapt to these conditions, their capability is limited. Therefore, the operation window of this type of vessel is limited, meaning the installation cost per installed offshore WTG will increase.

If today's system-a tagline-guideline system is used in combination with a floating crane, the lifted burden will follow the translational movements of the crane, which means the load of the crane will follow the crane synchronous and not be in rest relatively to the target in form of a wind turbine, a tower etc.

However also the target will have translational movements.

Translational movements of the tower and the fundament are typically not a one-directional oscillation. There will also occur a rotational movement with an elliptical pattern. The rotational movements may be limited but the oscillations will not be one-directional.

To optimize and increase the installation window for the floating installation vessel and thus reduce the cost of energy—there is a need to provide a solution to the problem with oscillation due to wind and wave conditions.

To optimize and increase the installation window for installation of onshore wind turbines there is also a need to provide a solution to the problem with oscillation due to wind. This is especially the case when a nacelle is mounted on the tower and the hub and blades shall be installed.

There are known damper systems for reducing oscillations in towers.

Conventional art comprises a tower damper system, which is a passive damper system (tuned mass damper) which is primarily suitable for onshore WTG's but is also used with limited success on offshore towers. This solution is a provisional tool that is removed from the WTG after installation. It has limited effect.

This passive damper system has drawbacks:
Limited effect. The length of the tower damper and mass of the pendulum limits the dampening effect. Can be very complicated to remove as the damper can be located on the backside of the tower compared to the installation vessel.

Conventional art also comprises a tower damper system, which is an active damper system. This system works by moving a mass in counter phase to the oscillations of the tower and nacelle combination. It measures the actual movements in the nacelle and counters the movements by accelerating a large mass in the horizontal plane.

This active damper has drawbacks:
Very costly. Complex design and it takes a relatively long time to install and start up the tool. Will only fit one nacelle geometry. Mass must be increased dramatically with increased dead load of the nacelle and tower. The solution has no effect as long the nacelle has not been installed on top of the tower, since the tool is a part of the Nacelle.

US 2021/0284506A1 discloses a system and a method being described by way of introduction and which are defined in the preamble of independent claims 1 and 13.

In this system there is a need for a tagline system for stabilizing the load during installation. Furthermore, a sensor arrangement is provided to detect a motion of the wind turbine assembly relative to the load.

This system also requires an actuator for adjusting the position of the load relative to the target in form of a wind turbine assembly and a control system which controls the actuator in order to reduce the relative movement. In other words, this system accepts the oscillations of the tower and nacelle and does not aim at reducing the oscillations of the tower and nacelle. Instead, the system uses the tagline system to induce oscillations in the load corresponding to the oscillations of the tower and nacelle.

This is a costly and complex design and is difficult to establish the synchronous oscillations which reduces the detected relative motion.

Therefore, there is a need for a wind turbine installation system for installation of an offshore or an onshore wind turbine and which in an efficient and cost-effective way is able to reduce to the oscillations in the tower and thereby stabilize the tower.

The installation system may be advantageous if it is based on conventional art technology.

### SUMMARY

An aspect relates to a wind turbine installation system and method for installation an offshore or an onshore wind turbine which makes it possible to reduce oscillations in a tower or a fundament (for an offshore wind turbine) in order to increase the operation window for the installation.

It is a further aspect of embodiments of the invention that the installation system and method may be suitable for cooperating with conventional art systems for installation in a precise and secure way without posing a risk to personnel when installing the wind turbine component.

The aspect is obtained with a wind turbine installation system and which is peculiar in that the winch has a winch motor and a bi-directional rotational spool with a strap, wherein the winch is placed in a distance from the tower, wherein the strap is provided with attachment means, for a controlled pull on the tower or the nacelle, that the control system comprises tension sensor means for determining strap tension and spool rotation sensor means for determining spool rotation, and wherein the control system is controllably connected to the winch motor for controlling spool rotation in order to induce counter movements to the oscillations in the tower and thereby stabilize the tower.

The wind turbine installation system according to embodiments of the invention for installation of an offshore wind turbine comprising a tower arranged on a fundament, is peculiar in that
the winch is placed on an installation vessel, wherein the strap is provided with attachment means, for applying a controlled pull on the tower, the nacelle or the fundament, the monitoring device is arranged for monitoring the movements/oscillation of the tower or fundament relative to the vessel and which monitoring device is arranged at the tower, the nacelle or the fundament, and wherein the control system is controllably connected to the winch motor for controlling spool rotation in order to induce counter movements to the oscillations in the tower or fundament and thereby stabilize the tower or fundament.

The wind turbine installation system according to embodiments of the invention for installation of an onshore wind turbine comprising a tower arranged on a fundament, is peculiar in that the winch is placed on the ground, wherein the strap is provided with attachment means, for attachment to the tower or the nacelle of the wind turbine.

It is desirable that the attachment means is attached to the tower, the nacelle or the fundament of the wind turbine, however it is also possible that the attachment means is fixed to a vessel or the ground and that the winch is arranged on the vessel or on the ground as explained later.

The system comprises at least one winch and a winch control system, the winch has a winch motor and a bi-directional rotational spool with a strap, wherein the winch is placed on an installation vessel, wherein the strap is provided with attachment means for attachment to a tower, a nacelle or a fundament of the wind turbine and for applying a controlled pull on the tower, nacelle or fundament, that the control system comprises a monitoring device, which is arranged for monitoring the movements/oscillation of the tower relative to the ground when installing an onshore wind turbine or relative to the vessel when installing an offshore wind turbine and which monitoring device is arranged at the tower, nacelle or fundament, that the control system comprises tension sensor means for determining strap tension and spool rotation sensor means for determining spool rotation, and wherein the control system is controllably connected to the winch motor for controlling spool rotation in order to induce counter movements to the oscillations in the tower and thereby stabilize the tower.

An embodiment of the system for installation of an offshore wind turbine is peculiar in that the wind turbine installation system comprises two winches, each of the winches having a winch motor and a bi-directional rotational spool with a strap, wherein the winches are placed on the installation vessel, wherein each strap is provided with attachment means for attachment to the tower, the nacelle or the fundament of the wind turbine and for applying a controlled pull on the tower, the nacelle or the fundament.

An embodiment of the system according for installation of an onshore wind turbine is peculiar in that the wind turbine installation system comprises two winches, each of the winches having a winch motor and a bi-directional rotational spool with a strap.

Both embodiments with two winches is furthermore peculiar that the straps are arranged with a mutual angle, which angle is between 40° and 120°, between 45° and 110° and between 75° and 95°, and/or 90°.

In embodiments, the method according to the invention is peculiar in that the method comprises the steps of
providing the winch with a winch motor and a bi-directional rotational spool with a strap, wherein the strap is arranged for applying a controlled pull on the tower or the nacelle, and
providing the winch control system which comprises tension sensor means for determining strap tension and spool rotation sensor means for determining spool rotation, and wherein the control system is controllably connected to the winch motor for controlling spool rotation,
providing attachment means for attachment to the strap,
placing the winch for establishing a distance between the winch and the attachment means, be placing the winch in a distance from the tower,
positioning a monitoring device, which is arranged for monitoring the relative movements/oscillation of the tower,
connecting the monitoring device with the control system,
tying the strap between the winch and the attachment means,
activating the winch motor until preset strap tension is reached in the strap,
monitoring the relative movements/oscillation of the tower relative to a ground when installing an onshore wind turbine or relative to a vessel when installing an offshore wind turbine,
during movement/oscillations of the tower, the control system activates the winch motor for rotation, if necessary, the spool with a rotation speed to counteract these movements hereby damping the movements of the tower until a pre-set limit for the oscillation is reached,
conducting the installation procedure for the wind turbine component to be installed,
relieving the tension in strap by rotating the spool, and
disconnecting the attachment means.

In embodiments, the method for installation of an offshore wind turbine is peculiar in that the method comprises the steps of
providing an installation vessel provided with the crane for lifting wind turbine components
providing the winch on the tower or fundament or on the installation vessel,
providing the attachment means for the strap on the vessel or on the tower, a nacelle or the fundament for the offshore wind turbine, wherein the strap is arranged for applying a controlled pull on the tower, the nacelle or the fundament,
positioning the monitoring device at the tower, the nacelle or the fundament,
positioning the installation vessel at a site of installation of the offshore wind turbine,
tying the strap between the winch and the attachment means,
monitoring the relative movements/oscillation of the tower or fundament relative to the vessel,
during movement/oscillations of the tower or fundament, the control system activates the winch motor for rotation, if necessary, the spool with a rotation speed to counteract these movements hereby damping the movements of the tower or fundament until a pre-set limit for the oscillation is reached.

In embodiments, the method for installation of an onshore wind turbine is peculiar in that the method comprises the steps of
providing the winch on the tower or on the ground in a distance from the tower,
providing the attachment means for the strap on the ground in a distance from the tower or on the tower or the nacelle,
applying a controlled pull on the tower or the nacelle.

An embodiment of the method for installation of an offshore wind turbine is peculiar in that the method comprises the steps of
providing a winch arrangement, comprising two winches, each of the winches having a winch motor and a bi-directional rotational spool with a strap, wherein the winches are placed on the installation vessel, wherein each strap is provided with attachment means for attachment to the tower, the nacelle or the fundament for the offshore wind turbine, wherein the straps are arranged for applying a controlled pull on the tower, the nacelle or the fundament, and wherein the control system is controllably connected to each winch motor for controlling spool rotations,
activating the winch motors until preset strap tensions is reached in the two straps, and
during movement/oscillations of the tower, the control system activates the winch motors for rotation, if necessary, the spools with a rotation speed to counteract these movements hereby damping the movements of the tower until a pre-set limit for the oscillation is reached.

An embodiment of the method for installation of an onshore wind turbine is peculiar in that the method comprises the steps of
providing a winch arrangement, comprising two winches, each of the winches having a winch motor and a bi-directional rotational spool with a strap, wherein the winches are placed on the ground, wherein each strap is provided with attachment means for attachment to the tower or the nacelle, wherein the straps are arranged for applying a controlled pull on the tower or the nacelle, and wherein the control system is controllably connected to each winch motor for controlling spool rotations,
activating the winch motors until preset strap tensions is reached in the two straps, and
during movement/oscillations of the tower, the control system activates the winch motors for rotation, if necessary, the spools with a rotation speed to counteract these movements hereby damping the movements of the tower until a pre-set limit for the oscillation is reached.

In embodiments for the method comprising the step of providing two winches is furthermore peculiar in the step of
ensuring that the mutual angle between the straps is between 40° and 120°, between 45° and 110° and between 75° and 95°, and/or 90°.

As used in the present application the term “relative movements/oscillation of the tower” will mean the movement/oscillation of the tower relative to a ground in connection with an onshore wind turbine and the movement/oscillation of the tower relative to the vessel in connection with an offshore wind turbine.

As used in the present application the term “a distance” will mean a length which may be within a large interval ranging from 10 to 300 m. or even larger. This length will depend on different parameters, for example the of the height of the tower, the surroundings where the wind turbine is placed and equipment used for the installation.

The installation system and the method reduce the oscillation amplitude of the wind turbine tower sufficient for the installation work to be carried out at times when this was not previously possible.

Embodiments of the invention further minimize the risk and danger to both crew and equipment.

It is desirable to arrange the winch, or the winches, on the installation vessel and the attachment means arranged on the tower, the nacelle or the fundament.

However, for an offshore wind turbine, it is alternatively possible to have the winch, or the winches, arranged on the tower, the nacelle or the fundament and to have the attachment means arranged on the vessel.

And for an onshore wind turbine it is alternatively possible to have the winch, or the winches, arranged on the tower or the nacelle and to have the attachment means arranged on the ground. The attachment means may for example be arranged at a vehicle or a fundament mounted in the ground. When installing more wind turbines in a wind park it may be possible to have a few fundaments and to use redirection roller as explained below for installing more wind turbines.

These two alternatives may especially be used in embodiments where only one winch is used. In such situation the winch may be maintained in the tower or the nacelle and used as a service crane in the wind turbine.

In short, the control involves that when the tower moves away from the winch, the winch motor will raise the torque, thereby attenuating the amplitude of current oscillation. The amplitude of the tower oscillation can only be actively attenuated when the position of the tower moves away from the winch. When the tower moves towards the winch, the winch motor will pull with as little torque as possible, which ensures that the strap is rolled up and kept tightened so that it can be used for attenuation when the tower moves away from the winch again. When the strap is kept tightened the attenuation effect may be induced from the beginning of the movement away from the winch.

It shall be understood that the oscillation of the tower will normally comprise a linear oscillation which may be combined with a rotational movement following an oval curve and not only a one-directional oscillation.

Even though the oscillation comprises a combination of the linear oscillation and an oval rotational movement it will be sufficient to attenuate the oscillation with a one-directional pull only by using one winch.

This is especially the case if the direction between the winch and the tower is parallel with the main axis for the rotational movement. However even if the direction between the winch and the tower is transversal to the main axis for the rotational movement an attenuation is obtained.

Moreover, embodiments of the invention also foresee that more than two winches are used for obtained a larger degree of attenuation. This is possible in situation where the available space for arranging the winches allows the use of more winches.

However, it is advantageous to use two winches arranged with mutual angle in order to attenuate the oscillations which comprises the rotational movement. By arranging the mutual angle between the straps ensures that an attenuation is provided even if a substantially linear oscillation occurs which is transverse to a direction between the tower and the vessel.

As the vessel is arranged at one side of the tower the winches cannot be arranged on each side of the tower. Therefore, the tower oscillation can only be actively attenuated when the position of the tower moves away from the winch. But it shall also be understood that the oscillations of the tower can result in situation where the oscillating movement will move the tower away from the first winch and towards the second winch. The control system will also take such situation into account. The winch motors are individually dynamically controlled, and they may apply opposite directed torque to the tower as well as they are able to apply torques with different magnitude.

Moreover, it is to be noted that in an embodiment it is possible to arrange the winches on different vessels, for example an installation vessel in combination with a supply barge, if this is necessary to have a sufficient large mutual angel between the straps. In such situation it might also be possible to arrange a vessel on opposite sides of a tower whereby it is possible to attenuate the oscillations in two oppositely directed directions.

According to embodiments of the present invention the straps may be fastened to a wind turbine tower, when the tower is erected. It is desirable to attach the straps close to the top of the tower.

However, a monopile fundament for the offshore wind turbine may be arranged with a length where is also advantageous to use the attenuation principle. The monopile may be affected by ocean currents and oscillate. Therefore, instead of fastening the straps to the tower it is possible that the straps are fastened to a monopile on which a tower section is mounted. In such situation there may often be provided a transition piece and the strap or straps may be attached to such transition piece.

The attachment of the strap to the tower may be affected by providing an interface on the tower. Alternatively, the attachment can be a sling which is led around the tower at the top. The sling or interface is connected to the strap wound up on the winch. Alternatively, a line can be used as a drawstring to connect the straps to the tower.

The winch motors may be hydraulically or electrically driven.

In an embodiment the winch motors are electrically equipped with encoders that accurately measure the position of the winch motors and thus speed. The torque of the winch motors is programmed to be dependent on the encoder. Frequency converters (VFD) are used for driving the winch motors.

The VFDs allow the winch motors to be controlled with vector control, which means that the torque of the motors can be controlled directly from the VFD. The winch motors are each equipped with an encoder which is connected to each motor's VFD. The encoder provides the VFD with information about the position and speed of the winch motor, allowing the winch motor torque to be precisely controlled, even at low speeds.

It is desired to establish the control so that if the speed increases, with a pull in the strap, then the winch motor torque increases, while if the speed decreases, with a slack in the strap, then the torque decreases. This control mode is simple and three is no requirements for geometrical compensations. Since the winch motors always react in relation to themselves and the feedback coming from the strap, the control is not influenced by the way it is connected to the tower. The efficiency of such control is dependent on the movement of the tower being clearly communicated through the line to the winch motor.

With embodiments of the present invention it is achieved that the installation of WTG components is made possible under wind and wave conditions which otherwise would make the installation impossible.

Furthermore, a continuous monitoring of the movements may be affected by the control system without the need for user input. The control system may stop an installation process in case the control system registers that preset limits are about to be-/are exceeded limits.

Tests shows that the installation system and the method according to embodiments of the invention is an efficient installation tool for floating vessels and jack up vessels, which reduces the oscillations in a way which may provide an operational limit of up to wave heights of 2.5 m wind speed of 16-18 m/s. This will increase the operation window for installation.

Furthermore, by tests and calculations performed, it has been found that the tower oscillations can be attenuated quickly, and it has shown that a preset limit for amplitude of the oscillations may be reached in less than 10 min. The attenuation has high attenuation efficiency even in unfavorable geometric conditions and the oscillation amplitude is quickly reduced to the preset acceptable amplitude. The preset acceptable amplitude may be between 30 and 70 mm, and/or approximately 50 mm.

The control system used in the installation system and method according to embodiments of the present invention is based on principles disclosed in European Patent EP 2 526 042 of the same applicant for controlling a rotation of a load, for example a windmill blade around a bearing wire.

Even though embodiments of the invention are described in connection with use for installation it is to be understood that the system and method according to embodiments of the invention may also be used for service work on a wind turbine and for uninstalling of a wind turbine.

The control system measures the movement of the wind turbine tower. Based on this measurement of the tower movements, the control system activates the winches to counteract these movements hereby creating a damping the movements of the tower. This is affected until tower a pre-set limit for the oscillation is reached. Typically, an amplitude of 50 mm is an acceptable limit.

The winches may provide for a tension or a slack in the straps.

The winches are individually dynamically controlled by the wind turbine tower's own movement to counteract this movement pattern. The movement of the tower and the nacelle are monitored by one or more accelerometers or other monitoring device that actively communicate with the control system.

The control system is provided for controlling the operation of the winch motors. The winch motors may operate simultaneously with the same or dissimilar rotation speeds. Thus, the winch motors may operate individually. The control system comprises tension sensor means for determining the tension in the straps and spool rotation sensor means for determining the position and the operation of the spool. The sensors are operating continuously during use of the installation system to provide feedback of the operation to the control system.

The control system may be provided with an output means for providing the sensor measurements to the crane operator or a data logger. Furthermore, the control system may be provided with warning signals provided to the crane operator, when preset limits are about to be-/are exceeded. This will enable the crane operator to interrupt the installation and bring the load into a safe condition if for example the wave and/or wind conditions change, and oscillations exceeds a predefined limit. As mentioned above control system may also be arranged for interrupting the installation without the need that the crane operator manually effect an interruption.

There is used a first winch and a second winch. The winches are controlled mutual depending on each other. The winches may be identical or different. Rotating the spools with a rotation speed performs the winding/unwinding. The control system is controlling the spool rotation of the winch by controlling the winch motor based on tension sensor measurements. The control system is using the spool rotation sensor measurement as feedback to verify correct spool rotation.

The second winch may be set to follow the first winch. In a symmetrical condition the rotation speed of the second winch is equal to the rotation speed of the first winch. In an asymmetrical condition the rotation speed of the second winch is not equal to the rotation speed of the first winch.

According to an embodiment, the wind turbine installation system is peculiar in that the monitoring device, which is arranged for monitoring the relative movements/oscillation of the tower comprises an accelerometer.

The accelerometer is placed at top of the tower (or the top of a monopile fundament). Therefore, the given maximum and permissible tower amplitude is converted to a corresponding acceleration. This is done by differentiating the formed position curve, in this way speed and acceleration curves can be formed for the tower. The maximum acceleration for the tower can thus be found.

A maximum permissible acceleration may be found for the actual tower. For each tower, the maximum acceleration may correspond to a tower amplitude of for example 400 mm and the maximum permissible acceleration may correspond to a tower amplitude of for example 50 mm.

According to an embodiment, the wind turbine installation system is peculiar in that the wind turbine installation system comprises a transition piece arranged to be attached to the tower or in case of an offshore wind turbine a fundament for the tower and that the strap or straps are attached to the transition piece.

Hereby it is possible in a technically simple way to establish an attachment point for the attaching the straps to the tower or the fundament in case of an offshore wind turbine.

According to an embodiment, the wind turbine installation system is peculiar in that the wind turbine installation system comprises a redirection roller for each strap.

If the winch or winches are arranged in a fixed position on a vessel, it will be possible provide redirection rollers for each strap. Such redirection rollers may be placed on the vessel in such a way that the mutual angle between the straps is established when two winches are used.

The winch or winches may be arranged in a fixed position on the ground, for example on a fundament or vehicle arranged in a fixed position. It will be possible provide redirection rollers for each strap. Such redirection rollers may be placed on the ground in such a way that the mutual angle between the straps is established when two winches are used.

Moreover, the redirection roller may also influence on the angle established between the tower and each strap.

Hereby, it is possible to adjust the mutual angle between two straps and also in an easy way adjust the angle between the tower and each strap.

According to an embodiment, the wind turbine installation system is peculiar in that the control system comprises a frequency converter or frequency converters for driving the winch motor or winch motors.

The use of frequency converters allows the winch motor or winch motors to be controlled with vector control. As explained earlier this means that the torque of the motors can be controlled directly from the frequency converters. This control of the winch motors creates the possibility for a technical simple and very precise control.

According to an embodiment, the wind turbine installation system is peculiar in that the that the connection between the control system and the sensors and/or the control system and each winch motor is wireless.

It is herewith achieved that the control system may be located away from the sensors and winches.

This is especially advantageous because the system does not require electrical wiring to be applied between the various parts of the system on the vessel and the parts on the tower or fundament. The system is therefore easy to install in temporary installations with a minimal installation time.

According to an embodiment, the method is peculiar in that the method comprises the step of
providing a redirection roller for each strap.

In accordance with a further aspect where two winches are used the method comprises the step of
arranging the redirection rollers to obtain the desired mutual angle between the straps.

As mentioned above the redirection roller for a strap is a technical simple solution for obtaining a desired mutual angle between the straps and also a desired angle between a strap and the tower.

According to an embodiment, the method is peculiar in that the method comprises the steps of
providing a frequency converter or frequency converters for the control system,
driving the winch motor or the winch motors with the frequency converter or the frequency converters, and
controlling the winch motor or winch motors with vector control, for controlling the torque of the winch motor or the winch motors directly from the frequency converter or the frequency converters.

As mentioned above the use of frequency converters for controlling the winch motors is precise controlled which makes it possible to use vector control. Hereby the torque of the motors can be controlled directly.

According to an embodiment, the method for installation of an offshore wind turbine is peculiar in that the method comprises the steps of
providing a transition piece,
attaching the transition piece to the tower, the nacelle or the fundament and
attaching the strap or straps to the transition piece.

According to an embodiment, the method for installation of an onshore wind turbine is peculiar in that the method comprises the steps of
providing a transition piece,
attaching the transition piece to the tower or the nacelle and
attaching the strap or straps to the transition piece.

When attaching the strap to a transition piece it is easy to adapt attachment means for the strap or straps with corresponding attachment means on the transition piece. The transition piece will especially be of interest when it is a fundament of the tower in an offshore wind turbine where oscillations should be attenuated in the fundament due to influence from wave movements and ocean flows.

In such situation the transition piece will normally be arranged on the fundament before arranging a tower on the fundament.

The installation system of embodiments of the present invention is suitable for cooperation with the system disclosed in European Patent EP 2 526 042 of the same applicant. The control system to be used in embodiments of the present invention is a modification of the control system disclosed in EP 2 526 042 where the control system is used for controlling the rotation of a component around a bearing wire which is used for suspending a load in crane. However, the system may be modified for use with one strap or two straps in attenuating the oscillations in a tower or monopile fundament.

The use on one winch or two winches to reduce the influence from wind on a wind turbine tower or fundament is an efficient system for effecting an installation in a precise and secure way without posing a risk to personnel when installing the wind turbine component.

It may be possible to replace the winch with other types of actuators. For example, linear actuators of piston cylinder type may be used. Such actuators may be hydraulically or electrically driven. Such actuators should be arranged to be controlled by the control system in order for the actuators to work so that when the tower moves away from the winch, the winch actuator will raise the pull effect, thereby attenuating the amplitude of current oscillation and be able to tighten the strap when the tower moves against the actuator.

A linear actuator may be used alone or in combination with a winch.

The important feature for embodiments of the invention is that the system includes use of one or more actuation mechanisms with tension and slack function.

The actuation mechanisms shall be individually dynamically controlled by the movement of the tower or fundament to counteract this movement pattern.

The movement of the tower, nacelle or fundament are monitored by one or more monitoring devices, typically accelerometers, that actively communicate with the actuation mechanism via a control system.

Tests and calculation have illustrated that an attenuating effect is obtainable with traction forces in the magnitude of 65 kN to 250 kN. These traction forces are obtainable with winches which in the conventional art are used for tagline tension and for guide wire tension.

Accordingly, it is possible to use conventional art winches in the installation system according to embodiments of the present invention.

### BRIEF DESCRIPTION

Some of the embodiments will be described in detail, with references to the following Figures, wherein like designations denote like members, wherein:

FIG. 1 illustrates a top of a tower and a nacelle and illustrating the oscillations of the tower relative to a crane;

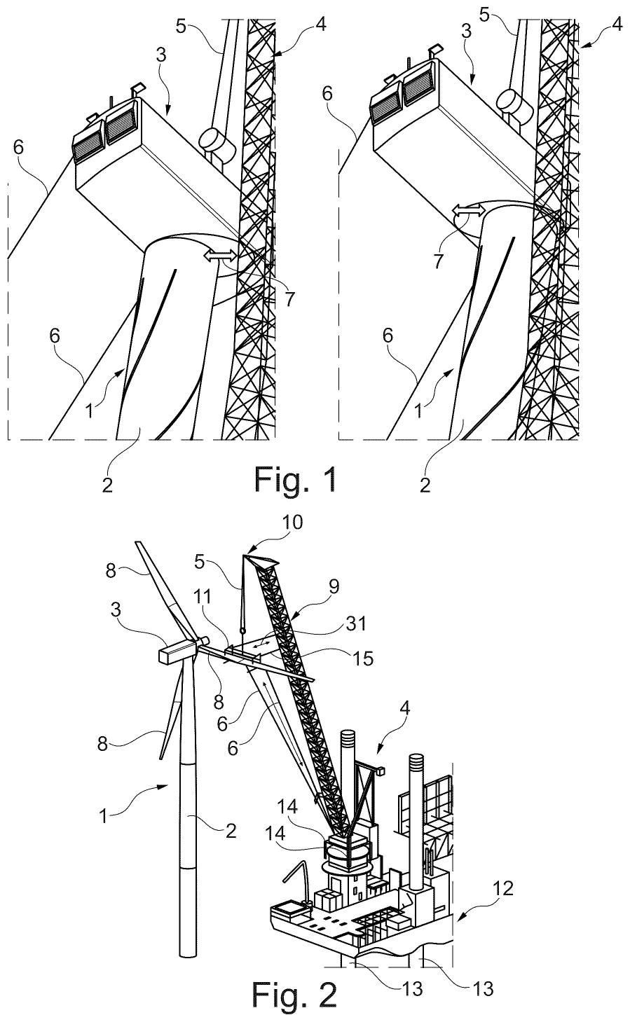

FIG. 2 illustrates a conventional art vessel with a crane using a tagline master system for offshore installation of a wind turbine blade:

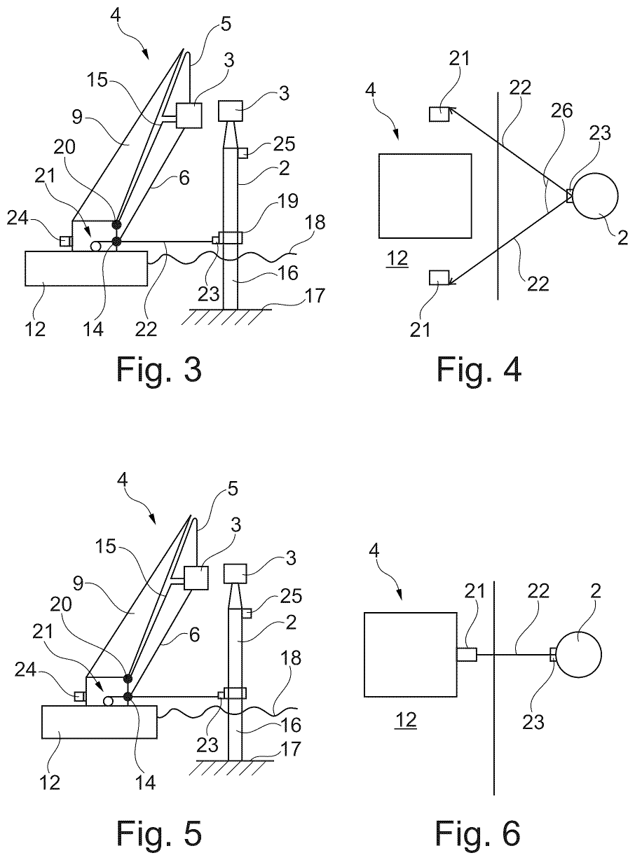

FIG. 3 illustrates a sketch as seen from the side of a system according to embodiments of the present invention,

FIG. 4 illustrates a sketch of the system illustrated in FIG. 3 as seen from above;

FIG. 5 illustrates a sketch corresponding to FIG. 3 of an embodiment of a system;

FIG. 6 illustrates a sketch of the system illustrated in FIG. 5 as seen from above:

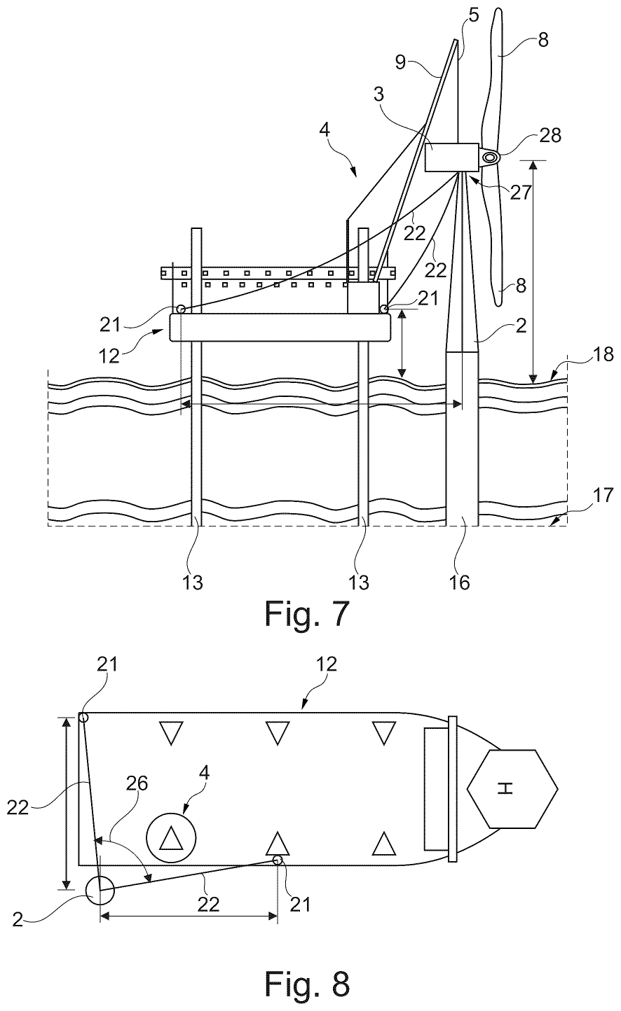

FIG. 7 illustrates a sketch illustrating an embodiment for the wind turbine installation system seen from the side:

FIG. 8 illustrates a sketch of the embodiment of FIG. 7 seen from above:

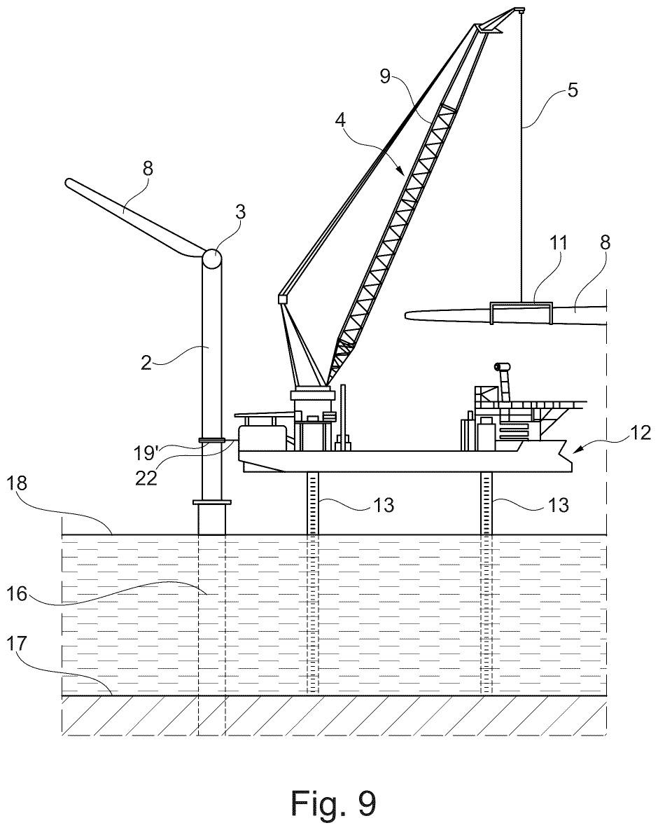

FIG. 9 is a sketch illustrating another embodiment for the wind turbine installation system as seen from the side:

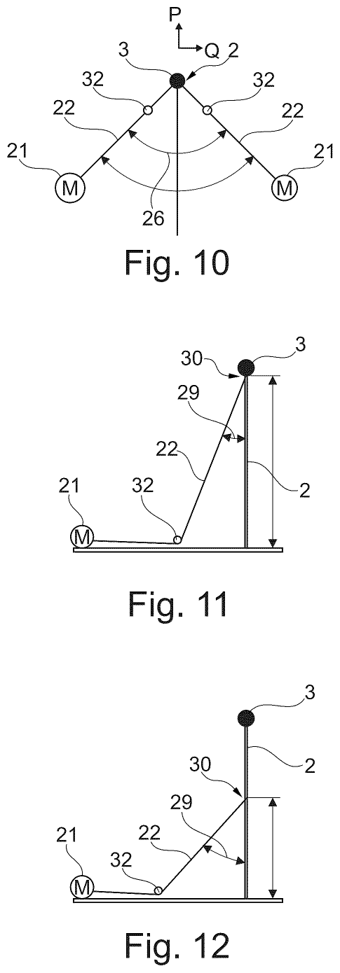

FIG. 10 is an illustration seen from above to illustrate a mutual angle between two straps being attached to the tower:

FIG. 11 illustrates a sketch seen from the side corresponding to FIG. 10 illustrating use of redirection rollers in a first position:

FIG. 12 illustrates a sketch corresponding to FIG. 11 illustrating use of redirection rollers in a different position:

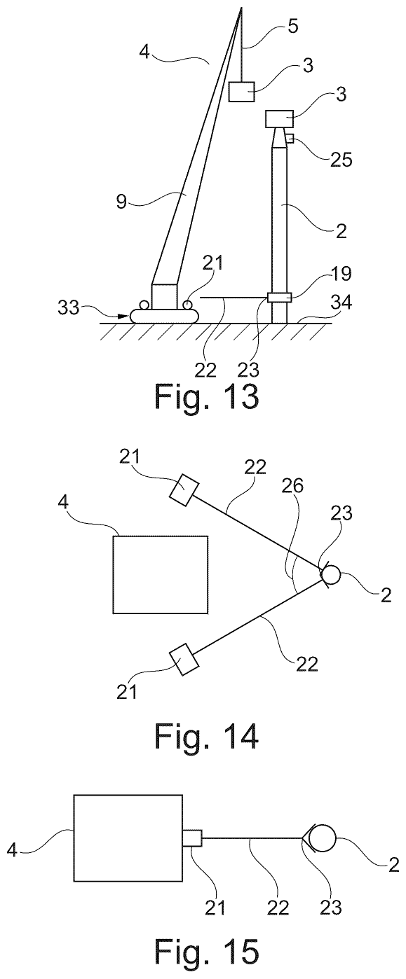

FIG. 13 is a sketch corresponding to FIG. 3 of a system according to embodiments of the present invention for installation of an onshore wind turbine:

FIG. 14 is a sketch of the system illustrated in FIG. 3 for installation of an onshore wind turbine; and

FIG. 15 is a sketch corresponding to FIG. 6 of an embodiment for a system for installation of an onshore wind turbine.

### DETAILED DESCRIPTION

FIG. 1 illustrates a conventional art installation in order to illustrate the oscillations. The offshore wind turbine 1 comprises a tower 2. On top of the tower a nacelle 3 is arranged. Moreover, a crane 4 is used for the installation. 5 illustrates bearing wire used for installation of the nacelle 3 on top of the tower 2. In FIG. 1 also two taglines 6 are visible. The difference between the illustration to the left in FIG. 1 and to the right in FIG. 1 clearly shows the oscillation and thereby the different distances occurring between the tower 2 and the crane 4.

The oscillations in the tower are due to influence from wind, waves and ocean currents.

In the illustrations in FIG. 1 the nacelle 3 hanging in the bearing wire 5 is kept in constant position whereas the tower 2 is subject to substantial oscillations. In practise it has shown that the oscillations may have an amplitude of 400-500 mm for an offshore wind turbine.

The oscillating is illustrated with the double arrow 7 at the bottom of the nacelle 3.

FIG. 2 illustrates a conventional art system with taglines. The offshore wind turbine is illustrated comprising the tower 2 with nacelle 3 and blades 8.

The crane 4 comprises a crane boom 9 where the bearing wire 5 is arranged at the top 10 of the crane boom 9. The taglines 6 are attached to a yoke 11 which is connected to the bearing wire 5. In the present situation the yoke 11 is illustrated in an operation for installation of a blade 8.

The crane 4 is arranged on an installation vessel 12 comprising legs 13 to be arranged at the seabed 17 (see FIG. 3) during installation.

In the crane there are provide tagline winches 14 for the taglines 6 and also lifting winches (not illustrated) for the bearing wire 5 are provided.

Moreover, the illustrated crane 4 has guide wires 15 which is connected with the yoke 11. The double arrow 31 illustrates how the guide wires 15 may move the yoke 11 closer to the crane boom 9 or further away from the crane boom 9.

FIG. 3-6 illustrate sketches of a system according to embodiments of the present invention.

The tower 2 is connected to a monopile fundament 16 which is mounted at the seabed 17 below the sea level 18.

The monopile fundament 16 comprises a transition piece or a connecting platform 19 on which the tower 2 is attached.

The side views in FIGS. 3 and 5 are for illustrative purposes illustrated with the nacelle 4 arranged in the bearing wire 5 and being connected with the taglines 6 and the guide wires 5.

In FIGS. 3 and 5 there is an illustration of a guide wire winch 20 connected with the guide wire 15.

FIGS. 3 and 4 illustrate that two winches 21 are arranged at the installation vessel 12. Each winch 21 is connected with a strap 22. Each of the straps 22 are provided with attachment means or attachment 23 for attachment to the tower 2. In the illustrated situation the attachment is affected through the transition piece 19.

Alternatively, the straps 22 may be connected directly to the tower 2.

Each winch 21 comprises a winch motor and a by-directional rotation spool on which the strap 22 is arranged. Such winches are known per see, e.g. from European patent EP 2,526,042.

As illustrated in FIG. 4 the two straps 22 are arranged with a mutual angle 26. In the illustrated situation the angle is approximately 90°. However, the angle may vary between 40° and 120° depending on the position of the winches 21 on the installation vessel 12 and the distance between the installation vessel 12 and the tower 2.

The embodiment illustrated in FIGS. 5 and 6 are different from the embodiment illustrated in FIGS. 3 and 4 in that only one winch 21 and one strap 22 is provided for attachment to the tower 2.

The installation system comprises a control system indicated with a box 24 in FIGS. 3 and 5. Such control system is also described in more detail in the above mentioned European Patent.

Furthermore, the system comprises a monitoring device indicated at 25 in FIGS. 3 and 5. The monitoring device may typically be an accelerometer. The monitoring device 25 monitors the oscillations in the tower 2 relatively to the installation vessel 12.

The control system 24 is arranged for controlling the winches 21 individually based on the movement of the tower 2 in order to counteract the oscillations or other movement pattern which may involve a circular movement of the tower.

The control system 24 is communicating with the monitoring device 25, typically by a wireless connection. Moreover, the control system 24 is connected with the winches 21 for controlling their movement in order to establish the desired counteract movement pattern. In that respect the control system 24 has tension sensor means or tension sensor for determining strap tensions and spool rotation sensor means or spool rotation sensor for determining spool rotation. These sensor means or sensors are of the type disclosed in the above-mentioned European patent.

FIG. 7 is a sketch of an embodiment for the wind turbine installation system where the winches 21 are arranged at opposite sides of the installation vessel 12. FIG. 7 illustrates that the straps 22 are attached at a top position 27 of the tower 2.

In FIG. 8 the installation system of FIG. 7 is illustrated as seen from above. It is seen that the winches 21 are arranged on the installation vessel 12 in positions which makes it possible to obtain a mutual angle 26 being approximately 90°. Tests have shown that such mutual angle gives the best possible attenuation of the oscillations in the tower.

The installation vessel 12 used may have a size in the magnitude of 60×120 m and the height of the winches 21 above the sea level 18 might be in the magnitude of 20 m. The height between sea level 18 and a hub 28 of the wind turbine may be 120-150 m.

It is noted that the above dimensions are only for illustrative purposes and is not limiting the scope of the height for towers and the size of installations ships which may be used in a system and a method according to embodiments of the present invention.

FIG. 9 illustrates another embodiment of the wind turbine installation system as seen from the side.

FIG. 9 corresponds more or less to FIG. 7. However, here it is illustrated that the straps 22 are arranged substantially horizontal from the winch (not illustrated) of the vessel 12 to attachment means 19′ which is arranged in a position of the tower 2 in the same height above sea level 18 as the position of the winches 21 (not illustrated).

The attachment means 19′ may be a sling or rope arranged around the tower 2 and provided with attachment means for cooperating with the attachment the straps 22.

The situation illustrated in FIG. 9 may be used in connection with one or two winches 21 arranged on the installation vessel 12.

FIGS. 10-12 illustrate the mutual position of winches relative to the tower 2.

In the embodiments illustrated in FIGS. 10-12 redirection rollers 32 are arranged for each strap 22. Hereby it is possible to have a fixed position of the winches 21 on the installation vessel 12 and change a position of a redirection roller 32 in order to obtain the desired angle 26 between the two straps 22 independently of the position of the winches 21. This is advantageous, seeing that the winches may be securely attached at the installation vessel in fixed positions. The redirection rollers 32 may be easily arranged in a position at the vessel where it is convenient in order to obtain the desired angle 26.

Moreover, the use of redirection rollers 32 also makes it possible to change an angle 29 between the tower 2 and the portion of the strap 22 being provided between the redirection roller 32 and the point of attachment 30 to the tower.

As a further comment to the use of redirection rollers 32 it should be realised that an attachment point 30 should be arranged as high as possible on the tower 2. However, in some situations the attachment point 30 would be arranged at a lower position on the tower.

The point of attachment 30 may also be arranged at the top of a monopile fundament 16, seeing that the ocean current may cause oscillations in the monopile fundament, which should be attenuated when arranging a tower on the monopile fundament 16.

FIGS. 13-15 differs from the embodiments illustrated in FIGS. 3-6 in that the system is for installation of an onshore wind turbine.

In FIGS. 13-15 the crane 4 is arranged on an undercarriage 33 standing on the ground (34) where also the tower 4 for an onshore wind turbine is arranged. A guide wire 15 and taglines 6 may also be provided in these embodiments but are omitted for clarity.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A wind turbine installation system for installation of an onshore or offshore wind turbine comprising a tower and a nacelle arranged on a fundament, wherein the system comprises:
a crane arrangement and at least one winch,
a control arrangement which comprises a winch control system and a monitoring device, which is arranged for monitoring the relative movements/oscillation of the tower relative to a ground when installing an onshore wind turbine or relative to a vessel when installing an offshore wind turbine and the monitoring device is arranged at the tower or nacelle,
wherein the winch has a winch motor and a bi-directional rotational spool with a strap, wherein the winch is placed in a distance from the tower, wherein the strap is provided with an attachment, for applying a controlled pull on the tower for the nacelle, that the control system includes a tension sensor for determining strap tension and a spool rotation sensor for determining spool rotation, and wherein the control system is controllably connected to the winch motor for controlling spool rotation in order to induce counter movements to the oscillations in the tower and thereby stabilize the tower.

2. The wind turbine installation system according to claim 1 for installation of an offshore wind turbine, where the winch is placed on an installation vessel, wherein the strap is provided with the attachment, for attachment to the tower, the nacelle or the fundament of the wind turbine and for applying a controlled pull on the tower, the nacelle or the fundament, the monitoring device is arranged for monitoring the movements/oscillation of the tower or fundament relative to the vessel and which monitoring device is arranged at the tower, the nacelle or the fundament, and wherein the control system is controllably connected to the winch motor for controlling spool rotation in order to induce counter movements to the oscillations in the tower or fundament and thereby stabilize the tower or fundament.

3. The wind turbine installation system according to claim 2, wherein the wind turbine installation system comprises two winches, each of the winches having a winch motor and a bi-directional rotational spool with a strap, wherein the winches are placed on the installation vessel, wherein each strap is provided with the attachment for attachment to the tower, the nacelle or the fundament of the wind turbine and for applying a controlled pull on the tower, the nacelle or the fundament.

4. The wind turbine installation system according to claim 1, wherein the wind turbine installation system comprises a transition piece arranged to be attached to the tower or the fundament for the tower and that the strap or straps are attached to the transition piece.

5. The wind turbine installation system according to claim 1 for installation of an onshore wind turbine, wherein the winch is placed on the ground, wherein the strap is provided with the attachment, for attachment to the tower or the nacelle of the wind turbine.

6. The wind turbine installation system according to claim 5, wherein the wind turbine installation system comprises two winches, each of the winches having a winch motor and a bi-directional rotational spool with a strap.

7. The wind turbine installation system according to claim 2, wherein the, that the straps are arranged with a mutual angle, which angle is between 40° and 120°, between 45° and 110° and between 75° and 95°, and/or 90°.

8. The wind turbine installation system according to claim 1, wherein the wind turbine installation system comprises a transition piece arranged to be attached to the tower and that the strap or straps are attached to the transition piece.

9. The wind turbine installation system according to claim 1, wherein the monitoring device, which is arranged for monitoring the relative movements/oscillation of the tower comprises an accelerometer.

10. The wind turbine installation system according to claim 1, wherein the wind turbine installation system comprises a redirection roller for each strap.

11. The wind turbine installation system according to claim 1, wherein the control system comprises a frequency converter or frequency converters for driving the winch motor or winch motors.

12. The wind turbine installation system according to claim 1, wherein the connection between the control system and the sensors and/or the control system and each winch motor is wireless.

13. A method for installation of an onshore or offshore wind turbine comprising a tower and a nacelle arranged on a fundament, which method comprises:
providing a crane for lifting wind turbine components and positioning the crane at a site of installation of the wind turbine,
providing a winch arrangement, comprising at least one winch,
providing a control arrangement which comprises a winch control system and a monitoring device, which is arranged for monitoring the relative movements/oscillation of the tower and which monitoring device is arranged at the tower,
positioning a monitoring device, which is arranged for monitoring the relative movements/oscillation of the tower relative to a ground when installing an onshore wind turbine or relative to a vessel when installing an offshore wind turbine,
connecting the monitoring device with the control system,
wherein the method comprises the steps of
providing the winch with a winch motor and a bi-directional rotational spool with a strap, wherein the strap is arranged for applying a controlled pull on the tower or the nacelle, and
providing the winch control system which includes a tension sensor for determining strap tension and a spool rotation sensor for determining spool rotation, and wherein the control system is controllably connected to the winch motor for controlling spool rotation,
providing an attachment for attachment to the strap,
placing the winch for establishing a distance between the winch and the attachment, be placing the winch in a distance from the tower,
tying the strap between the winch and the attachment,
activating the winch motor until preset strap tension is reached in the strap,
monitoring the relative movements/oscillation of the tower relative to the ground when installing an onshore wind turbine or relative to the vessel when installing an offshore wind turbine,
during movement/oscillations of the tower, the control system activates the winch motor for rotation, if necessary, the spool with a rotation speed to counteract these movements hereby damping the movements of the tower until a pre-set limit for the oscillation is reached,
conducting the installation procedure for the wind turbine component to be installed,
relieving the tension in strap by rotating the spool, and
disconnecting the attachment.

14. The method according to claim 13 for installation of an offshore wind turbines wherein the method comprises:
providing an installation vessel provided with the crane for lifting wind turbine components
providing the winch on the tower or fundament or on the installation vessel,
providing the attachment for the strap on the vessel or on the tower, the nacelle or the fundament for the offshore wind turbine, wherein the strap is arranged for applying a controlled pull on the tower, the nacelle or the fundament,
positioning the monitoring device at the tower, the nacelle or the fundament,
positioning the installation vessel at a site of installation of the offshore wind turbine,
tying the strap between the winch and the attachment,
monitoring the relative movements/oscillation of the tower or fundament relative to the vessel,
during movement/oscillations of the tower or fundament, the control system activates the winch motor for rotation, if necessary, the spool with a rotation speed to counteract these movements hereby damping the movements of the tower or fundament until a pre-set limit for the oscillation is reached.

15. The method according to claim 14, wherein the method comprises:
providing a winch arrangement, comprising two winches, each of the winches having a winch motor and a bi-directional rotational spool with a strap, wherein the winches are placed on the installation vessel, wherein each strap is provided with the attachment for attachment to the tower, the nacelle or the fundament for the offshore wind turbine, wherein the straps are arranged for applying a controlled pull on the tower, the nacelle or the fundament, and wherein the control system is controllably connected to each winch motor for controlling spool rotations,
activating the winch motors until preset strap tensions is reached in the two straps, and
during movement/oscillations of the tower, the control system activates the winch motors for rotation, if necessary, the spools with a rotation speed to counteract these movements hereby damping the movements of the tower until a pre-set limit for the oscillation is reached.

16. The method according to claim 13 for installation of an onshore wind turbine the method comprises:
providing the winch on the tower or on the ground in a distance from the tower,
providing the attachment for the strap on the ground in a distance from the tower or on the tower or the nacelle,
applying a controlled pull on the tower or the nacelle.

17. The method according to claim 13 for installation of an onshore wind turbine wherein the method comprises:
providing a winch arrangement, comprising two winches, each of the winches having a winch motor and a bi-directional rotational spool with a strap, wherein the winches are placed on the ground, wherein each strap is provided with the attachment for attachment to the tower or the nacelle, wherein the straps are arranged for applying a controlled pull on the tower or the nacelle, and wherein the control system is controllably connected to each winch motor for controlling spool rotations,
activating the winch motors until preset strap tensions is reached in the two straps, and
during movement/oscillations of the tower, the control system activates the winch motors for rotation, if necessary, the spools with a rotation speed to counteract these movements hereby damping the movements of the tower until a pre-set limit for the oscillation is reached.

18. The method according to claim 15 for installation of an onshore wind turbine wherein the method comprises:
ensuring that a mutual angle between the straps is between 40° and 120°, between 45° and 110° and between 75° and 95°, and/or 90°.

19. The method according to claim 13, wherein the method comprises:
providing a redirection roller.

20. The method for according to claim 19, wherein the method comprises:
arranging the redirection rollers to obtain the desired mutual angle between the straps.

21. The method for according to claim 13, wherein the method comprises:
providing a frequency converter or frequency converters for the control system,
driving the winch motor or motors with the frequency converter or the frequency converters, and
controlling the winch motor or the winch motors with vector control, for controlling the torque of the winch motor or the winch motors directly from the frequency converters.

22. The method according to claim 13, wherein the method comprises:
providing a transition piece,
attaching the transition piece to the tower, the nacelle or the fundament and
attaching the strap or straps to the transition piece.

23. The method according to claim 13, wherein the method comprises:
providing a transition piece,
attaching the transition piece to the tower or the nacelle and
attaching the strap or straps to the transition piece.
